(19) United States
(12) Patent Application Publication
(10) Pub. No.: US 2023/0252506 A1
(43) Pub. Date: Aug. 10, 2023

(54) SYSTEM AND METHOD FOR REAL-TIME REMOTE SURVEYING

(71) Applicant: Felipe Juan Joaquin Polito, Lake Forest, CA (US)

(72) Inventor: Felipe Juan Joaquin Polito, Lake Forest, CA (US)

(21) Appl. No.: 18/164,034

(22) Filed: Feb. 3, 2023

Related U.S. Application Data
(60) Provisional application No. 63/267,571, filed on Feb. 4, 2022.

(51) Int. Cl. G06Q 30/0203

(52) U.S. Cl. CPC G06Q 30/0203; G06Q 2230/00

(57) ABSTRACT

A real-time remote surveying system having a survey module configured to transmit a question to participants and have the questions be received by the participants; a voting module in data communication with the survey module, the voting module being configured to record participant responses to the question, automatically generate voting data and transmit the voting data; a numeration module in data communication with the voting module, the numeration module being configured to receive voting data from the voting module and automatically produce and display survey results in real-time; and a data management module in data communication with the numeration module, the data management module being configured to store voting data and survey results. The real-time remote surveying system may be configured to automatically generate voting data and survey results in real-time, while maintaining the anonymity of participants, ensuring that public opinion may be measured in real-time and without bias.

### CROSS-REFERENCE TO RELATED APPLICATIONS

This application claims the benefit of U.S. Provisional Application No. 63/267,571, filed Feb. 04, 2022, which is hereby incorporated by reference, to the extent that it is not conflicting with the present application.

### BACKGROUND OF INVENTION

### 1. Field of the Invention

The invention relates generally to a system and method for surveying and specifically to a system and method for remote surveying in real time.

### 2. Description of the Related Art

Market research can generally be described as the gathering of information about a target market and/or customer. Market research helps to identify and analyze the needs of the market, the market size, and the competition, and is a very important component of business strategy and a major factor in maintaining competitiveness. Its techniques encompass both qualitative techniques such as focus groups, in-depth interviews, and ethnography, as well as quantitative techniques such as customer surveys, and analysis of secondary data.

A survey is a type of market research where one or a plurality of questions are asked to gather information (“polling”) from a particular group of individuals, or qualified respondents/voters/participants. The respondents must be both willing to participate and possess the necessary characteristics required for participation in the particular survey. The process of recruiting such qualified respondents is often complex, time consuming, and expensive. However, efficiently assigning and conducting surveys to qualified respondents offers tremendous value to all parties involved.

Generally, survey systems and methods begin by generating one or more questions and multiple answer options per each question. Then, the survey can be administered through a variety of mediums, including in-person interviews, online questionnaires, telephone calls, text messages, or even “clicker” technology either in-person or through on-line platforms. Respondents/ participants respond by choosing one of the options presented, sending a signal from the user-device to the server. While various survey methods exist and are well known in the industry, said survey methods are often time consuming, confusing, and expensive and may utilize sources and produce results that are difficult for the public to verify. Furthermore, existing survey methods do not consider the social impact that survey answers provide when the answers are easily visible to others. Lastly, surveys are often inconvenient and time consuming to conduct.

Therefore, there is a need to solve the problems above by proving a system and method of real time, remote surveying that overcomes the limitations described hereinabove by being quick and easy to conduct, as well as being intuitive and transparent.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, a real-time remote surveying system is provided, the real-time remote surveying system comprising: a plurality of end-devices, each end-device of the plurality of end-devices being configured to receive a response from a corresponding participant and automatically generate corresponding voting data in real-time; a broadcasting system configured to broadcast a question to each participant; at least one data collector configured to be in data communication with each end-devices of the plurality of end-devices and the internet, each data collector of the at least one data collector being configured to receive voting data from each end-device of the plurality of end-devices; a datacenter configured to be in data communication with the internet, such that the datacenter is in data communication with the at least one data collector, the datacenter comprising: an application server having a plurality of modules configured to facilitate operation of the real-time remote surveying system; and a database server in data communication with the application server, the database server being configured to receive voting data from the at least one data collector and compile the voting data from each data collector to form a complete dataset; wherein the datacenter is configured to process the complete dataset to automatically generate survey results in real-time; and a client machine configured to be in data communication with the internet, such that the client machine is in data communication with the datacenter, the client machine being configured to query the datacenter to allow an end user to access the survey results in real-time. One advantage is that each participant’s answer may be made publicly visible through the usage of a lighting system on the end device, which may be an important social aspect of the survey. Another advantage is that the automation and ease of use of the real-time remote surveying system may reduce the effort required by a participant to participate, thus potentially increasing the likelihood of their participation, while also using said automation to reduce the client work burden. Another advantage is that the real-time remote surveying system may be configured to always be operational while the participant is present, providing the participant with questions without requiring any initial action from them. Another advantage is that useful metadata such as location of the vote, time of the vote and historical voting results may be captured automatically alongside participant answers, allowing for filtering of data based upon the interests of the surveyor. Another advantage is that end-devices and other surveying system elements may be configured to prevent duplicate voting results from being collected through the usage of metadata. Another advantage is that the real-time remote surveying system may include an external auditing system, which may be used to allow a member of the public to access collected voting data and verify survey results, thus providing result transparency. Another advantage is that clients and other end users may access and view survey results in real-time, allowing clients to rapidly gauge public opinion.

In another aspect, a real-time remote surveying system is provided, the remote surveying system comprising: a survey module configured to transmit a question to participants and have the questions be received by the participants; a voting module in data communication with the survey module, the voting module being configured to record participant responses to the question, automatically generate voting data and transmit the voting data; a numeration module in data communication with the voting module, the numeration module being configured to receive voting data from the voting module and automatically produce and display survey results in real-time; and a data management module in data communication with the numeration module, the data management module being configured to store voting data and survey results.. Again, an advantage is that each participant’s answer may be made publicly visible through the usage of a lighting system on the end device, which may be an important social aspect of the survey. Another advantage is that the automation and ease of use of the real-time remote surveying system may reduce the effort required by a participant to participate, thus potentially increasing the likelihood of their participation, while also using said automation to reduce the client work burden. Another advantage is that the real-time remote surveying system may be configured to always be operational while the participant is present, providing the participant with questions without requiring any initial action from them. Another advantage is that useful metadata such as location of the vote, time of the vote and historical voting results may be captured automatically alongside participant answers, allowing for filtering of data based upon the interests of the surveyor. Another advantage is that end-devices and other surveying system elements may be configured to prevent duplicate voting results from being collected through the usage of metadata. Another advantage is that the real-time remote surveying system may include an external auditing system, which may be used to allow a member of the public to access collected voting data and verify survey results, thus providing result transparency. Another advantage is that clients and other end users may access and view survey results in real-time, allowing clients to rapidly gauge public opinion.

In another aspect, a method of real-time remote surveying system is provided, the method of real-time remote surveying comprising the steps of: broadcasting a question; facilitating the receipt of the question by a plurality of participants; allowing each participant having an end-device of the plurality of participants to input a response to the question into a corresponding end-device; generating voting data automatically in real-time from each participant’s input response; facilitating the transmission of the voting data from each end-device to at least one data collector; transmitting voting data from the at least one data collector to a datacenter; storing the voting data from each data collector on a database server, the voting data transmitted from each data collector being compiled into a complete dataset; processing the complete dataset stored within the datacenter into survey results; and allowing an end user to access the survey results in real-time through a client machine in data communication with the datacenter. Again, an advantage is that each participant’s answer may be made publicly visible through the usage of a lighting system on the end device, which may be an important social aspect of the survey. Another advantage is that the automation and ease of use of the real-time remote surveying system may reduce the effort required by a participant to participate, thus potentially increasing the likelihood of their participation, while also using said automation to reduce the client work burden. Another advantage is that the real-time remote surveying system may be configured to always be operational while the participant is present, providing the participant with questions without requiring any initial action from them. Another advantage is that useful metadata such as location of the vote, time of the vote and historical voting results may be captured automatically alongside participant answers, allowing for filtering of data based upon the interests of the surveyor. Another advantage is that end-devices and other surveying system elements may be configured to prevent duplicate voting results from being collected through the usage of metadata. Another advantage is that the real-time remote surveying system may include an external auditing system, which may be used to allow a member of the public to access collected voting data and verify survey results, thus providing result transparency. Another advantage is that clients and other end users may access and view survey results in real-time, allowing clients to rapidly gauge public opinion.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates a real-time remote surveying network wherein a datacenter is in communication with a voting device and a client machine, according to an aspect.

FIG. 2 illustrates the modules of the disclosed real-time remote survey system in data communication with various real-time remote survey system elements, according to an aspect.

FIG. 3 illustrates the process flow diagram of the disclosed real-time remote surveying method, according to an aspect.

FIG. 4 illustrates a computer system suitable for implementing the aspects of an end-device within the disclosed real-time remote surveying system, according to an aspect.

FIG. 5A illustrates a front view of an embodiment of an end device having selection buttons and voting lights, according to an aspect.

FIG. 5B illustrates a front view of an embodiment of an end device having illuminated voting buttons, according to an aspect.

FIG. 6A illustrates the front perspective view of an embodiment of mountable end device, according to an aspect.

FIG. 6B illustrates a front view of a windshield mountable voting light, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

As used herein and throughout this disclosure, the term “mobile device” refers to any electronic device capable of communicating across a mobile network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH.RTM. networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user’s usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled elements across the figures (e.g., 116 and 316, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

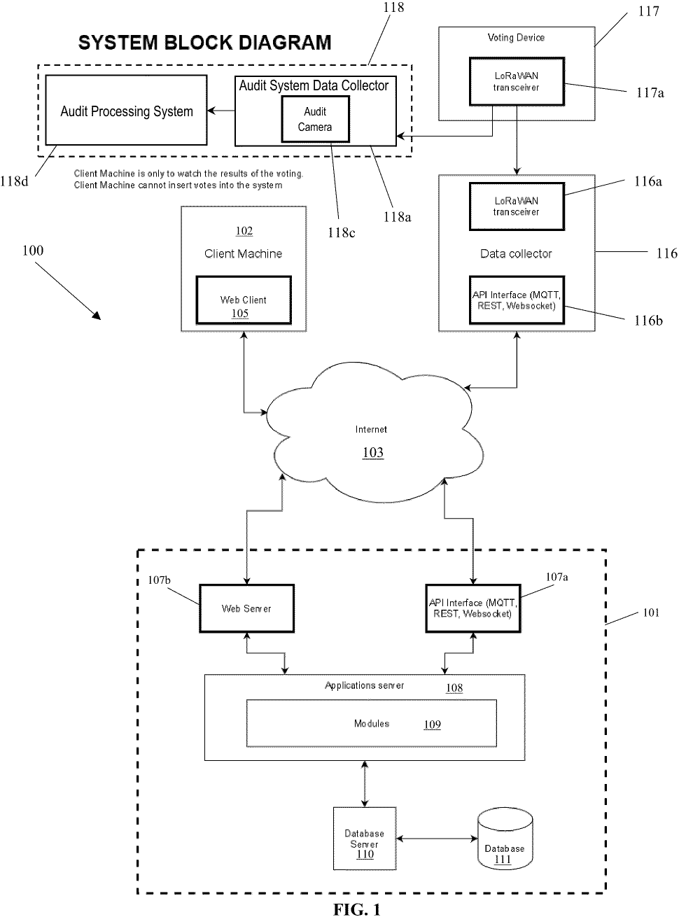

FIG. 1 illustrates a real-time remote surveying network 100 wherein a datacenter 101 is in communication with a voting device 117 and a client machine 102, according to an aspect. The process illustrated in FIG. 1 provides an example overview of a potential real-time remote surveying network 100 configured to collect voting data (“answer data”) from voting devices for storage within a database 111, for subsequent access/distribution to a client using a client machine 102. The process may begin with a voter (“participant”) driving their car while listening to a radio station on their in vehicle radio. In an embodiment, a radio station operator at a radio station may broadcast a yes or no question, or another question having two possible answer options, provided by a surveyor/client, over the radio to be heard by those tuned into said station. The voter may have a voting device (“end-device”, “end device”) installed within their vehicle that allows them to provide an answer to the question asked on the radio by hitting a corresponding button on said voting device 117 to select one of the two answer options. In an alternative embodiment, a radio station may broadcast a question having more than two possible answer options. In said embodiment, a voter may operate a voting device configured to allow the voter to select one of a plurality of possible answers, such as a voting device having a plurality of buttons or a selection dial. After receiving a response submission from the voter, the voting device may produce a small confirmation light or confirmation audio cue to acknowledge to the voter that their vote has been recorded locally on the voting device 117. Once the voting device records the voter’s response (“answer”, “vote”, “vote result”, “voting results”), said voting device 117 may be configured to ignore additional response submissions for the current question/ survey question, thus locking in the voter’s initial response. Alternatively, the voting device may be configured to allow the user to change their response to a question by submitting an additional response input within a certain timeframe, such as before a submission period (“voting period”) for the question expires.

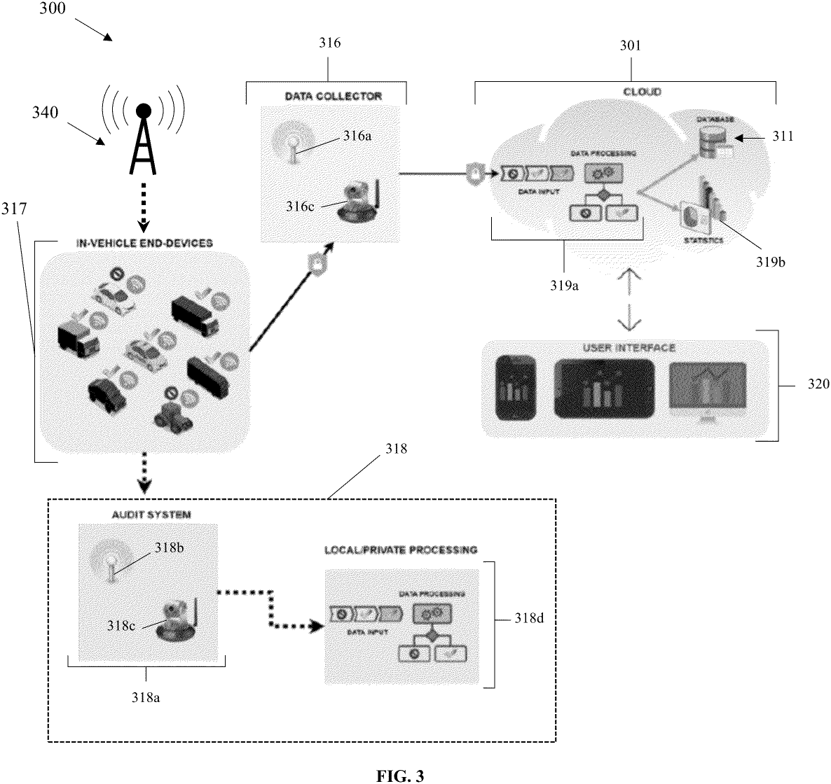

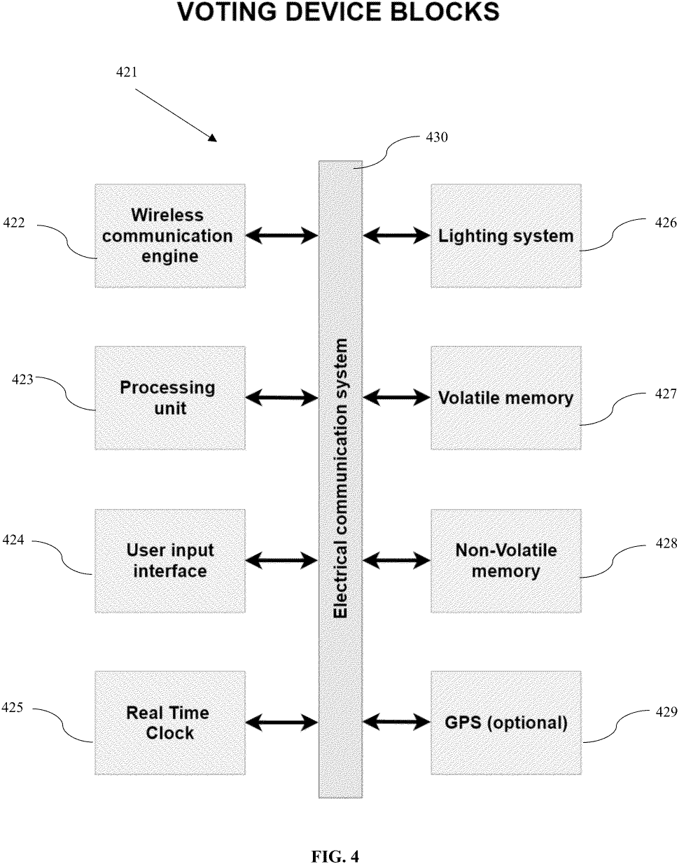

Upon recording the voter’s response locally (e.g. within the voting device 117), the voting device 117 may be configured to make the recorded response publicly visible, while also transmitting said response to a nearby data collector 116. The voting device 117 may have a lighting system (“voter light”, “voting light”), such as lighting system 426 of FIG. 4, wherein the pressing of a button (e.g., submission of a response) results in the emission of a corresponding color or pattern of light, based upon the response provided. This corresponding color or pattern of light may be readily recognized by a member of the public to correspond to a yes or no answer. Alternatively, the color or pattern of light may be readily recognized by a member of the public to correspond to a specific option number out of a plurality of potential options. This emission of a voting light that is readily visible to the public may provide the public with a mechanism to quickly audit the answers of nearby drivers visually, to gauge the public opinion on a certain topic or issue. This emission of a voting light may also be visible to a camera having a processing image algorithm, such as data collector camera 316c of FIG. 3, wherein said camera may be used to capture the response data as part of the data collector 116 or another comparable system. Alternatively, voters may also be allowed to submit their responses completely anonymously, such that the voter light does not display their response, and/or may simply provide an indication that the corresponding voter has participated, rather than their specific response.

The voting device (“end device”, “end-device”) 117 may be further comprised of a voting device transceiver (“end device transceiver”) 117a, such as a LoRaWAN transceiver, configured to facilitate the transfer of voting data from the voting device 117 to a data collector 116. Said data collector 116 may be comprised of a data collector transceiver 116a, such as a LoRaWAN transceiver that is configured to receive voting data from the voting device 117. The voting device transceiver 117a and the data collector transceiver 116a may be configured to be suitably compatible, and thus may use compatible wireless protocols, which will be discussed in greater detail herein below. Voting data may be comprised of not only the response (e.g., a yes or no answer) provided by the voter/participant, but also automatically generated information, such as a timestamp for the time the vote was cast, a unique device ID from the voting device, a “nonsense” and an optional GPS position. The described “nonsense” may be a counter, wherein said nonsense is added to a data payload prior to encryption, in order to avoid packet duplication. As a result, the encrypted data packet changes every time it is sent, thus helping to avoid a packet duplication attack. The voting data transferred from the voting device 117 to the data collector 116 may be encrypted and may utilize known mechanisms in the industry to maintain connection reliability while simultaneously being difficult to hack or otherwise access without proper authorization.

The additional information captured or automatically generated alongside the voter’s response as part of the voting data may play a crucial role in helping ensure the voter’s response is suitably paired with its corresponding question, while also preventing duplicate votes from being captured and/or recorded. By providing a timestamp as part of the voting data, it is possible to identify which question the voter’s response corresponds to, based upon the time the question was broadcasted and the time the response was submitted. This may be useful if multiple questions are being broadcasted to the same area on the same day, such that responses submitted for an earlier survey aren’t mistakenly attributed to a later survey. Additionally, each voting device 117 may have a unique device ID that is captured as part of the voting data. This unique ID may help to ensure that the same response from the same voter isn’t captured multiple times (potentially being recorded by multiple data collectors 116), or if it is, that duplicate responses may be identified and omitted. A nonsense may also be provided as part of the voting data wherein the purpose of said nonsense is to avoid attacks that cause packet cloning. If a GPS device is provided as part of the voting device, locational data may also be collected automatically by the voting device 117 in real-time at the voter’s discretion. In a preferred embodiment, the voting device 117 may be provided without a GPS or any position recording device, in order prioritize the protection of the voter’s privacy over collection of additional metadata. This locational data may be useful in further establishing a necessary “answer-to-question” relation, in instances in which questions may be asked in different broadcast areas at the same time. Locational data may also be provided from the data collector 116 used to collect the corresponding voting data, which will be discussed in greater detail hereinbelow.

As described hereinabove the data collector 116 may have a data collector transceiver 116a, such as a LoRaWAN transceiver, that is configured to receive the voting data in the form of information packets, while performing the necessary validation steps (“handshakes”) with the voting device 117 in order to securely receive said voting data. The transceivers 116a, 117a of the data collector 116 and the voting device 117 may utilize the same type of wireless protocol, such as LoRaWAN as seen in FIG. 1, or may otherwise be suitably compatible with each other. The data collector 116 may further supplement the collected voting data with additional metadata, such as the data collector GPS position, date received, a unique identifier for the voting device, etc., that may be used to establish or confirm a “answer-to-question” relation between the collected voting data and the broadcasted question. While a vote result may correspond to the simple “yes” or “no” provided by the voter, any additional information including the aforementioned timestamp, unique device ID, a nonsense, the GPS coordinates of the end device at the time the vote was input, as well as the extra data provided by the data collector 116 such as data collector location, and date and time received, may be referred to as “metadata”. As such, the voter’s response may be combined with metadata automatically generated by the voting device 117 in order to form voting data for the voter for a specific survey. It should be understood that the voter’s response may be collected by the voting device 117 anonymously, such that the identity of the voter is in no way linked to the voting device, the voter’s response, or any generated metadata. The data collector 116 may then utilize a connection to the internet 103 in order to forward the collected voting data from each voter to the cloud, prior to reaching a datacenter 101. The data collector 116 may utilize a data collector APIinterface 116b, such as MQTT, REST or WebSocket, in order to communicate with a corresponding datacenter API interface 107a included as part the said datacenter 101 through the internet 103. The data collector 116 may be a suitable communication tower or gateway that is capable of utilizing the selected wireless protocol to communicate with the voting device 117, while also being connected to the cloud/internet and by extension the datacenter 101. Depending on which wireless protocol is utilized, the voting data received by from the voting device 117 may or may not be parsed prior to reaching the datacenter 101.

In addition to acting as an intermediary between the voting device 117 and the datacenter 101, the data collector 116 may also provide acknowledgement back to the voting device 117 to show that its voting data has been collected, to confirm proper receipt of the voting data from the voting device. This acknowledgement may come in the form of an additional audio or light cue emitted by the voting device 117. The data collector 116 may also help keep time synchronized between the datacenter 101 and the voting device 117, such that the time frame for a vote, (e.g., the start and end times that define a voting period) may be established at the datacenter 101 and forwarded by the data collector 116 to the voting device 117. This communication between the voting device 117 and the datacenter 101 through the data collector 116 may allow the voting device 117 to be unlocked, allowing a vote to be cast, and re-locked after expiration of the allotted time period or entry of a response (e.g., a voting period), to ensure that each voting device only casts a single vote for a particular survey, and that said vote may only be cast during the allotted time period. After a response has been entered by a voter, the voting device 117 may become locked and disregard any further inputs from the voter until another voting period has started. In addition to the voting device 117 preventing additional inputs from being accepted within a voting period, the lighting system, which will be described in greater detail in FIG. 4, may also continue to display the submitted vote result, until the voting period has ended.

The datacenter 101 may be responsible for the storage and processing of the voting data collected from each voting device (and thus each voter) that sends a response to a survey. A database 111 in data communication with (e.g., stored within) a database server 110 may be responsible for the storage of raw collected voting data, as well as processed and analyzed data and statistics (e.g., survey results such as graphs, charts, etc.) for clients based on the collected voting data. The datacenter 101 may make use of automatically generated metadata such as unique device IDs in order to filter out potential duplicate voting data collected by different data collectors, as well as vote timestamps and real-time GPS positions/coordinates, if provided, to establish the prior discussed “answer-to-question” relation between collected voting data and the corresponding question. This ensures that the collected responses are being added to the results of their proper corresponding questions.

The datacenter API interface 107a, as well a web server 107b, may interface directly with an application server 108 having modules 109 configured to perform the datacenter operations necessary to facilitate the collection, processing, and distribution of information to and from the datacenter 101. The modules 109 may include a survey module, a voting module, a numeration module, and a data management module. Each module may perform tasks relevant to its corresponding title, each of which will be discussed in greater detail hereinbelow. The application server may be responsible for providing instruction to the various devices utilized for the disclosed remote surveying method.

After the voting data has been processed and any relevant statistics have been automatically generated to form survey results, wherein said survey results, as well as any other relevant statistics or raw data, may be made accessible to the ones who provided the question for the survey in real-time as they are collected (e.g., the client/surveyor). This data may be presented in an “on-demand” format by providing an adequate front-end interface, such as a web browser, mobile app, tabulated file, or any other suitable client presentable or client accessible interface. In the embodiment of FIG. 1, a web server 107b may be accessed by the client in order to access the collected voting data as well as any generated statistics, survey results and any other presentable materials. A client may access the web server 107b, and thus the desired information, through usage of a web client 105 on the client’s machine 102. Said web client 105 may utilize the internet 103 to communicate with the datacenter 101, wherein the web server 107b may be configured to facilitate the connection of the client machine 102 to the datacenter 101, and thus its collected voting data and survey results stored within the database 111. The collected voting data and survey results may be displayed to the client in real-time (e.g., as they are collected/processed/generated) in formats consistent with those known in the industry, including graphs, tables and figures, wherein said graphs, tables and figures may be generated by the datacenter 101 at will of the client. It should be noted that the voting data itself may not be modified by the client machine 102, though it may be filtered, grouped or arranged based on the client’s preference.

The disclosed remote surveying process discloses a fast and easy method of conducting a survey that is intuitive, transparent, and convenient. This is accomplished through utilization of a survey module, a voting module, a data management module, and a numeration module. These modules may be processor-instructed and in electrical communication with each other, thus working in conjunction with each other to provide a robust and intuitive application from which users may vote remotely in real time, with others being able to visually identify votes from different participants using the described lighting system. Furthermore, the disclosed surveying method may make public opinion representations readily available in a large scale and in very efficient time spans.

In a primary embodiment, a system and method for conducting a remote survey is provided. Participants, also called voters, may be drivers who choose one of two response options, such as “yes” or “no”, in response to questions broadcasted by radio station operator over a radio station to their in vehicle radio. This simple yes or no vote about a product, matter, or subject may be submitted by a participant using an end device 117, such as a plug-in voter appliance in the participants’ cars, wherein the participant’s response may then be broadcast to their surrounding population via a voter light and/or submitted anonymously via an emitted signal that can be collected and analyzed. Voting data from all voters on a corresponding survey may be compiled into a complete dataset within the database 111 of the datacenter 101, and the complete dataset may then be processed into survey results and presented to the surveyors, end users (“clients”) and the public through various methods, including public announcements on television or radio networks, or a computer-readable medium. It should be understood that the in-vehicle radio used to receive the question as part of the surveying module may be replaced by any suitable question receiver, such as a smartphone, smart device or internet enabled device, that is capable of receiving the question and transmitting/communicating it to the participant.

In an alternative embodiment, the present invention may conduct a survey based upon several factors, including broadcast capabilities, receiving limitations, and voting requirements. These and other embodiments will be subsequently shown. While alternative embodiments are anticipated, the present disclosure is not intended to be limiting to unexplored embodiments. These and other objectives of the disclosed real-time remote survey method and system will become obvious after reading the following detailed description. It is to be understood that the foregoing general description and the following detailed description are exemplary and are intended to provide further explanation of the invention as claimed.

Embodiments of the present invention are described herein in the context of a system and method for remote surveying in real-time. Those of ordinary skill in the art will realize that the following detailed description of said system and method for real-time remote surveying is illustrative only and is not intended to be in any way limiting. Other embodiments of the present invention will readily suggest themselves to such skilled persons having the benefit of this disclosure. Reference will be made in detail to implementations of the present invention as illustrated in the accompanying figures. The disclosed method for remote surveying may be performed in the order that it is discussed within the hereinabove accompanying description or said order may otherwise be altered to accommodate the needs of the application.

As described hereinabove, the real-time remote surveying method disclosed herein may be comprised of several primary steps, including: broadcasting a question; facilitating the receipt of the question by a plurality of participants; allowing each participant having an end-device of the plurality of participants to input a response to the question into a corresponding end-device; generating voting data automatically in real-time from each participant’s input response; facilitating the transmission of the voting data from each end-device to at least one data collector; transmitting voting data from the at least one data collector to a datacenter; storing the voting data from each data collector on a database server, the voting data transmitted from each data collector being compiled into a complete dataset; processing the complete dataset stored within the datacenter into survey results; and allowing an end user to access the survey results in real-time through a client machine in data communication with the datacenter. It should be understood that a large plurality of participants may vote in each survey, each using their own corresponding end device 117, and that one or multiple data collectors 116 may be utilized within different geographical regions to ensure that the voting data is collected from each corresponding end device 117, accordingly. These multiple data collectors 116 may be in data communication with a singular, overarching datacenter 101 having a database server 110, wherein the database server is responsible for housing a database 111 containing the complete dataset of voting data collected from each data collector 116, and thus each voting device 117. The collected voting data from all of the participants may then be queried by the client/end user through a client machine 102 that is in data communication with the datacenter 101.

As can be seen in FIG. 1, in addition to being in data communication with a data collector 116, each voting device 117 may also be in data communication with an audit system 118. The information collected and statistics generated by the audit system 118 may be made available to the general public, thus providing a mechanism for the general public to gauge the public response to a certain question/survey without interfacing with the datacenter 101. This in turn will help maintain transparency with voting data and survey results. As such, the disclosed real-time remote surveying system may be comprised of two independent and redundant systems: a “main” system which utilizes data collectors 116 in data communication with a datacenter 101 to collect all of the voting data for a particular survey to generate a complete dataset and overall survey results; and a “secondary” audit system 118 which utilizes an audit system data collector 118a in communication with an audit processing system 118d to collect only local data (only collected by the singular audit system data collector 118a) to generate local survey results.

In an embodiment, the audit system 118 may be comprised of an audit system data collector 118a in data communication with the voting device 117, and an audit processing system 118d in data communication with the audit system data collector 118a. The audit system data collector 118a may be comprised of an audit camera 118c configured to observe the corresponding voting light of each voting device 117. This will allow voting data to also be forwarded to the audit system 118 without having to interface with the datacenter 101 or even respond to the voting device 117. In an embodiment, the end device 117 may be configured to simultaneously display the participant response through an illuminated voting light, for collection by the audit system data collector 118a, and transmit the generated voting data using the transceiver 117a for collection by the data collector 116 that is in data communication data center 101. As such, an audit system data collector 118a and a data collector 116 may be positioned in close proximity to each other to ensure collection of comparable responses/voting data, accordingly. The audit system data collector may perform video processing on video recorded by the audit camera 118c to interpret the illuminated voting lights of cars driving on a freeway as voting data. It should be understood that the audit system data collector 118a may generate corresponding metadata based upon the time and location that the vote was recorded, etc.

Upon collecting voting data from end-devices 117 for a particular survey, the set of voting data collected by a particular audit system data collector 118a may be forwarded to an audit processing system 118d for processing. The audit processing system 118d may be configured to process all of the voting data received from the corresponding voting devices 117 and convert them into local survey results, similarly to the herein disclosed datacenter 101. These local survey results including, graphs, charts, figures, etc. may be made to be accessible/viewable by the general public, thus providing a publicly available mechanism for auditing the survey results. It should be understood that each audit system should be appropriately positioned to collect data from nearby voting devices, in order to ensure that the audit system data collectors 118a have access to the same voting data as the data collectors used for the main system (e.g., the datacenter 101) for a particular area. This may be done by installing an audit system 118 alongside each data collector 116, thus ensuring that members of the general public and the surveyor have access to the collected voting data, thus allowing both to be aware of public opinion on corresponding topics and issues.

It should be understood that in the embodiment of FIG. 1, the audit system 118 may not be configured to interface with the internet and may only utilize voting data collected from a singular corresponding audit system data collector 118a. As such, each audit system and its corresponding audit processing system 118d may only have access to voting data provided by voting devices that communicate directly with its corresponding audit system data collector 118a. As such, rather than each audit system 118 being capable of producing a singular batch of survey results, each audit system 118 may be configured to provide a set of local survey results which may differ from those generated by audit systems found in other locations, due to each audit system data collector potentially interfacing with different end devices. Alternatively, the audit system 118 may be implemented more similarly to the data center 101 and its corresponding data collectors 116, wherein all of the audit system data collectors 118a are configured to feed collected voting data into a singular database for processing and analysis. In such an alternative embodiment, members of the general public may still be able to access this alternative audit system, to allow them to assess public opinion on a certain issue. The audit system 118 and its various elements will be discussed in further detail hereinbelow.

The overall structure of the real-time remote surveying system 100 provides several unique capabilities by virtue of the hybrid question delivery/ voting data collection mechanisms described herein. The utilization of a radio station as the broadcasting system/mechanism allows for the utilization of already available public broadcasting systems in order to broadcast their questions in a manner that is efficient, affordable and capable of reaching a wide range of audiences without undue effort from any involved party. This also allows and provides radio stations with a rapid mechanism to engage with and educate the public in a broader way than some other polling systems are capable of. It should be understood that other known broadcasting systems, such as a cellular phone broadcasting systems, internet based broadcasting systems, etc., may also be utilized to broadcast questions to participants as applicable, as disclosed herein, but the radio station broadcasting system may be preferred for its affordability, wide range, use of existing infrastructure, etc. Because the voting device is in no way linked to the participant, the data is automatically collected anonymously, such that concealment of the collected data is not necessary to protect participants identities, as the results are inherently separate from each specific participants. The real-time remote surveying system thus facilitates a fast, affordable distribution of questions, subsequent high speed collection of input response and automatic generation of voting data and thus survey results, and real-time distribution of survey results to authorized parties, with minimal effort required by the participants and the surveyors, all while maintaining the anonymity of the participants by virtue of how responses are collected. The anonymous collection of voting data allows for all voting data to be stored within a centralized server without fear of a data breach comprising the personal information of a participant. Furthermore, historical and statistical information that is collected as metadata may be used to organize and filter responses or survey results accordingly to ensure that surveyors can access the information they desire.

In a preferred embodiment, each data collector 116 may be positioned on or adjacent to a freeway. By positioning each data collector 116 in such a location, several important capabilities may be enabled. For one, by positioning each data collector 116 on a freeway, it guarantees a large quantity of driving voters may pass by the data collector quickly, thus allowing each data collector to collect massive amounts of data in a relatively short time span. Another benefit of this positioning of the data collector on a freeway is that the vast majority of voters from which voting data may be received will be licensed adult drivers (individuals who are 18 year old or older), due to them driving in vehicle on a freeway. This may be particularly effective if the data collector is positioned on a type of road that is for whatever reason inaccessible to younger drivers, potentially due to local driving restrictions.

A benefit of the question being broadcasted over the radio is that the participant need not go looking for the question, it will simply be broadcast to them by virtue of being tuned into the radio station. Furthermore, participants that are merely driving their car, stuck in traffic, etc., are otherwise available to participate in the survey, as they likely do not have much else to do other than drive their vehicle. Answering a question using the described end-device 117 is as simple as pressing a single button once, and thus will not distract the driver participant, thus not providing a notable risk to the participant or those around them. Furthermore, because the question is broadcasted over the radio, participants may hear the question without having to search for it, and because the voting device is easy to use, voter participation may be increased by virtue of the low bar established to both hear and respond to the question.

It should be understood that the same question may be broadcasted by multiple different radio stations to ensure that listeners on all applicable stations have access to the same questions. This will ensure that the participants that are asked this question will be an unbiased sampling, unless such a bias is desirable for whatever reason, in which case the question may only be broadcasted on specific radio stations. Radio stations may be provided with said voting devices for distribution/sale to the public. In an embodiment, radio stations may be provided with financial incentives to both sell the voting devices and broadcast questions, which will help gain access to a wide audience of voters to avoid biased results when possible and desirable to do so.

Due to the importance of anonymity in making sure that a voter/participant is not influenced by those around them, public/societal pressures, etc., the real-time remote surveying system 100 may be configured to allow voters to remain completely unassociated with their own respective end device. This may be done by simply selling the voting device to anybody without any need for verification (as with a standard sale of a non-controlled item from a store) while also allowing the end device to be resold, gifted etc., such that each voting device is in no way linked to the participant using it. By providing a voting device that is no way linked to the participant or any of their devices (e.g., their phone, cell phone or computer), each participant may vote honestly without fear of being someway linked to their voting responses. Such an anonymous voting system may be desirable for organizations, such as the government or a corporation, to acquire an honest response from the general public. The anonymous submission of participant’s responses to their corresponding end device thus ensures that individuals opinions are collected while ensuring their anonymity is maintained

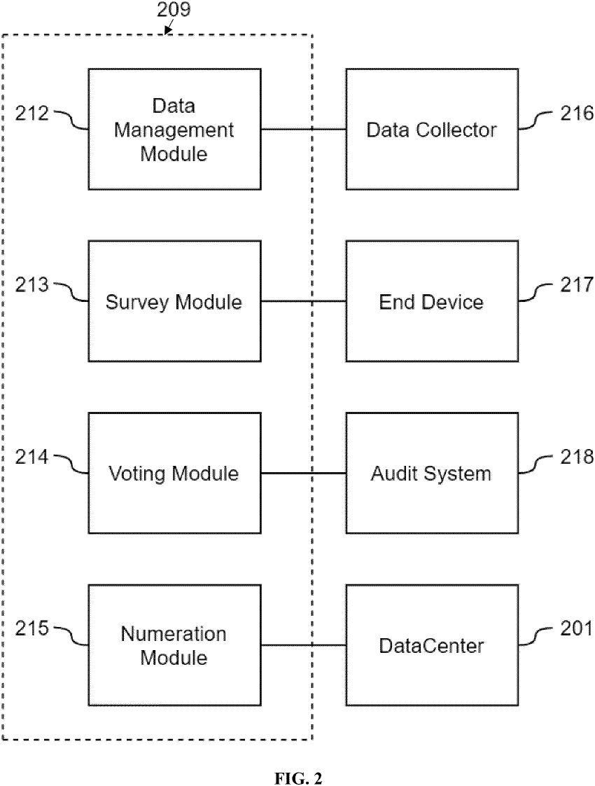

FIG. 2 illustrates the modules of the disclosed real-time remote survey system in data communication with various remote survey system elements, according to an aspect. It should be understood that the term “module” may be used to describe the physical, virtual or both physical and virtual elements of the corresponding real-time remote surveying system. The virtual elements of the disclosed modules may be referred to as applications 209 as within FIG. 2, or simply as modules 109 as within FIG. 1. The disclosed remote surveying system may comprise a survey module 213, a voting module 214, a data management module 212, and a numeration module 215. The survey module 213 may comprise a means to transmit questions to participants and have them be received by said participants. The voting module 214 may comprises a means to record/collect and transmit voter’s responses and associated metadata as voting data to the numeration module. The data management module 212 may comprise a means to store all voting data collected and generated from the disclosed remote surveying method. Lastly, the numeration module 215 may comprise a means to receive and process the voting data from the voting module 214, as well as compute and display survey results in real-time, to be stored in the data management module 212. These modules may be processor-instructed and in data communication with each other, working in conjunction with each other to provide a robust and intuitive system from which voters may vote in remotely in real time with others (the general public or other voters) potentially being able to visually identify votes from different users.

The horizontal lines shown interconnecting the elements of FIG. 2 are used to represent “data communication” between associated elements. The modules displayed in FIG. 2, including the data management module 212, the survey module 213, the voting module 214 and the numeration module 215 are used to represent virtual elements of their respective module, whereas the data collector 216, end-devices 217, the audit system 218 and the datacenter 201 elements may refer to physical elements. The data collector 216 may be in data communication with the data management module 212, in order to facilitate the transfer of answer data captured by the data collector 216 to the database server, such as database server 110 of FIG. 1. The survey module 213 may be configured to facilitate the broadcasting and receiving of the question, while the end-device may be responsible for capturing the voter’s response to the question. While the survey module 213 may not be in direct data communication with the end device 217, the voter may act as the intermediary between the survey module 213 and the end device 217 by hearing the question from a radio broadcast as part of the survey module 213 and then providing their response to the question using the end device 217. The voting module 214 may be in data communication with an audit system 218, in order to facilitate the transfer of answer data from in vehicle end-devices 217 to the audit system 218 for data verification and public access, as disclosed hereinabove. The details of the audit system 218 will be discussed in greater detail in FIG. 3. Finally, the numeration module 215 may be in data communication with the datacenter 201 elements in order to facilitate the processing of the obtained voting data into statistics, graphical representations and other desired end user materials. In addition to the described virtual aspects of the modules discussed previously, examples of the physical elements of the disclosed modules will be detailed hereinbelow.

In an exemplary embodiment, the present invention may be configured engage participating drivers in vehicles to express their preference through a simple yes or no vote about a product, matter, or subject via an end device 217, such as in-vehicle voter appliance (not shown). Said in-vehicle voter appliance may plug into said vehicle, have a rechargeable battery pack, and/or utilize any other suitable powering method known in the industry. A response indicating participant preference may be broadcasted to surrounding users via a voter light, and/or submitted anonymously via a transceiver emitted signal that can be collected and analyzed accordingly by a data collector 216. When responding to a broadcasted question/survey question, the participants may vote yes or no, and this selection may activate a corresponding element of the voter light, or, alternatively, may not activate the voter light if the participant elects to vote anonymously. A simple switch, or other functionally similar structure, may be provided on the end device 217 to enable this anonymous voting by selectively disabling the voter light. The voter light may generate a visible tally representation not only for individuals to observe the opinions of their surrounding population, but also for publicly placed information cameras to collect, as part of the data collector 216. The disclosed real time remote surveying system is configured to make public opinion representations readily available in a very efficient time span for marketing and/or research purposes.

In a preferred embodiment, the survey module 213 may be comprised of a radio network (not shown) used to broadcast a question asking a yes or no question and a car radio used to receive and play back the broadcast to the participant. As an example, a radio DJ/radio station operator may ask a question and broadcast this question to participants who are tuned in to their station. When the radio signal is received by an in-vehicle radio device, it may be played through the vehicle’s audio system, such that the question is broadcasted to the participant, who may then submit their answers to said question using the end-device 217 of the voting module 214. The term “end-device” 217 may be used to refer to any device on the participant’s end of the disclosed remote surveying system that facilitates the selection and transmission of the participant’s response and associated voting data to a data collector 216, such as a remote controller with a wireless transceiver.

While a radio network and an in-vehicle radio may be used for the survey module of the current embodiment, any means for sending questions to participants and having said participants receive the questions may be used, as long as it does not frustrate the purpose of the disclosed remote surveying method, such as transmitting a question over the internet to an end device having internet connectivity. In an alternative embodiment, questions may also be transmitted to a smartphone through text messages, calls, a dedicated application, etc., or another far reaching broadcasting method, as the broadcasting of the question doesn’t need to have the same level of privacy as the collection of vote results/voting data does. Radio broadcast may be a preferred mechanism for question transmission due to the ease of use, ease of reception by the participant, lack of distraction to the participant (as they will be driving), the existence of preexisting broadcasting infrastructure (radio stations are already build, radio receivers are present in most vehicles), etc. Similarly, the end-device 217 may be provided in a form that is not confined to a vehicle and may be provided as part of a handheld and portable device, such as a smart phone or other mobile device, though it may be preferred to have the end-device 217 be distinct from a participant’s smartphone, for the purposes of anonymity and security. In an embodiment, an end device app may be available for use on a participant’s smartphone, providing participants the option to be able to participate through said app on their smartphone.

The voting module 214 may comprise a means for receiving a response from a participant/voter and transmitting said response alongside any other collected/generated metadata to other modules. In a preferred embodiment, the voting module 214 may comprise an end-device 217 that receives a response from the participant, notifies the participant of the response they have selected after selection, and illuminates a voter light corresponding to the result. In this embodiment, only two selections may be available: “yes” or “no,” although more complex surveys can be used in alternative embodiments. The selection of “yes” or “no”, followed by the subsequent illumination of a corresponding voter light element, creates a visible, real-time tally representation that may be visible to the surrounding population. This may create an environment in which the selection of a participant may influence the selection of other participants. This social interaction may be used as an intentional aspect of the disclosed remote surveying method, although users may submit answers anonymously as well. Furthermore, the participation of voters, as made apparent by the illumination of their voting light, may encourage other potential participants to respond as well, even if the voting light merely indicates participation, rather than an actual response.

In addition to allowing voters to anonymously vote on issues by preventing a voting light from displaying their answer to nearby individuals, the voting device may also be configured to maintain the anonymity of the voter by not being attached, linked, or associated to the identity of the voter in any way, such that responses collected from a voting device cannot be linked to an individual using it. The voting module 214 may have a means of restricting voting on a specific survey to a set time period/voting period, as described with end device 217 hereinabove. The voting module 214, or more specifically the end device 217, may have a time lock (“TLock”) configured to prevent votes from being submitted for a survey beyond the time allotted to it or being submitted multiple times within the allotted time period. This time lock may be synchronized with a clock from the aforementioned datacenter, as a result of the end device’s communication with the data collector 216, and thus said datacenter 201.

Voting data may be transmitted in various ways. In a preferred embodiment, the voting data collected by the voting module 214 may be transmitted via wireless communication with data collectors 216 of the numeration module 215. In this embodiment, once participants make their selection, a roadside data collector 216 may receive the voting data from their end device 217 as it passes said data collector 216. The voting data collected or automatically generated by the data collector 216 may be sent to a storage server over a network, either at the end of each day or after an allotted time, depending on the purpose for the said data collection. When using a serverless architecture, the collected voting data may be “processed-on-the-fly” prior to sending it to the data management module 212. In alternative embodiments, the different voter light options may be distinguished from each other through using specific colors or shapes for each response. For example, providing a “yes” answer to the end-device 217 may result in the display of a glowing a green “+” light symbol on the lighting system and providing a “no” answer may result in the display of a glowing of a red “-” light symbol on the lighting system. The end-device 217 may get power from the vehicle through a plug, USB port, battery, solar panel, or other known power source. Elements of the end-device 217 that are configured to be manipulated by a participant, such as a remote controller, may be placed in a position that can be easily reached by the participant, while the lighting system/voting light may be positioned in a publicly visible location, such as on the windshield of the vehicle. It should be noted that the behavior of the end-device 217 may be configured remotely based off of instructions provided from the datacenter through the data collectors 216 to the end device 217 prior to starting each survey. Lastly, each participant may only be able to submit a response to a specific survey once, as their initial vote may be configured to prevent further voting on said survey, regardless of their continued travel resulting in their end device 217 being detected by other data collectors 216. Along with the actual response, additional metadata automatically generated by the end device in real-time may be stored and sent alongside the response as part of the voting data.

The data management module 212 may be comprised of a database server and a database accessible through said database server in a processor-instructed, computer-readable, non-transitory storage medium. The data management module 212 may be configured to receive voting data, store said voting data in said database, and provide query results for voting data searches within said database when used in conjunction with the numeration module 215. Voting data collected from each voter for a specific survey may be stored in a singular unified location as a complete dataset for convenience. As described previously, voting data may comprise a response, a unique device ID, a vote time, a vote date, a vote duration, a nonsense, etc. Voting data may further comprise ancillary data such as historical votes, comparisons to related votes, and any other data that can be used to analyze and/or compare past voting to current voting patterns. Once the data management module 212 is populated with the complete dataset of voting data, other modules, such as the numeration module 215, may query the data management module 212 with a voting session ID and receive answer data corresponding to that voting session (e.g., a particular vote). The data management module 212 may communicate with the data collector 216 in order to facilitate the secure transfer of collected voting data from the end devices 217 to the datacenter 201.

The numeration module 215 may comprise a data collector 216 configured to receive answer data from the voting module 214 and transmit collected answer data to the data management module 212 over a secure network. Furthermore, the data collector 216 may run local pre-processing algorithms for relevant data extraction, as needed. The data collector 216 may manage the voting data by providing different security mechanisms to ensure data integrity, prevent external attacks, and avoiding data injection from malicious sources. The data collector 216 may transmit the collected voting data to other elements of the numeration module 215, as well as datacenter 201 elements, in order to facilitate further processing and data refinement.

The numeration module 215 may further comprise a cloud-based portion configured to process the voting data stored within the datacenter 201 to obtain statistical results, generate graphs, charts and other visual representations for the survey conductor, and allow for the storage of said processed materials within the storage server. The numeration module 215 may be configured to allow the collected answer data and processed statistical results to be grouped or filtered based upon surveyor/client elected parameters or requirements, which may then be displayed through graphs, tabulated data, log files, or other means selected by the surveyor/client. This cloud-based portion of the numeration module 215 may transmit the statistical results, graphs and charts to a surveyor/client machine having a user interface, allowing a surveyor/client to view the graphs and other data collected and generated from a survey.

The numeration module 215 may also further comprise an audit system 218, wherein collected voter data and statistics may be made available for public inspection. The audit system 218 may be independent from the disclosed remote surveying system or integrated within it and may further comprise a means for authenticating votes and preventing fraudulent results by ensuring that only one vote is made, or otherwise collected/registered, for each end-device 217. This audit system 218 may be available for public use and inspection, unlike the cloud-based portion of the remote survey system described previously, that is made accessible to surveyors and/or other authorized end users. The audit system 218 may have its own data collection devices, data processing, statistics generation and result reporting means to allow for independent verification of data obtained and processed by the aforementioned cloud-based portion of the numeration module 215. As such, the voting module 214 may be responsible for forwarding its collected voting data not only to the datacenter 201 for client usage and inspection, but also to the independent audit system 218 for verification and public inspection.

While the above description contains specific details regarding certain elements, embodiments, and other teachings, it should be understood that embodiments of the disclosed real-time remote surveying system or any combination of them may be practiced without these specific details. These details should not be construed as limitations on the scope of any embodiment, but merely as exemplifications of the presently preferred embodiments. In other instances, well known structures, elements, and techniques may have been omitted for the purposes of more clearly presenting the invention.

FIG. 3 illustrates the process flow diagram of the disclosed real-time remote surveying method, according to an aspect. The provided process flow diagram of the disclosed real-time remote surveying system helps to provide context to the previously described modules, as well as how each element of disclosed real-time remote surveying system interacts and interconnects. After the broadcasting of a question from an element of the survey module, such as a radio station 340, server or other broadcast mechanism, the question may be received by the participant through a corresponding receiver device, such as an in-vehicle radio. As described hereinabove, an in-vehicle end device 317 may be configured to receive a survey response from a voter and transmit the resultant voting data (the response and any other collected data, such as the unique ID, GPS location, etc.) to a data collector 316. Said in-vehicle end-device 317 may include a remote controller configured to receive a participant’s response, convert it into voting data by including all necessary additional information/metadata and transmit said voting data to a data collector 316, and a visible voter light, configured to publicly display the answer provided by the participant. For simple yes or no questions, the remote controller may only have two input options, and the voter indication light may have only two possible lighting elements to selectively power, such as a “yes” light and “no” light. The participant’s answer may also be confirmed to the participant through a suitable mechanism, such as a visual or audio confirmation on the provided end device 317. The answer data transmitted by the in-vehicle end-device 317 may also be captured by an audit system 318, for independent and publicly accessible verification of results generated by client-side processes. The in-vehicle end-device 317 may be powered by the vehicle itself or alternative power sources, such as an included battery. The end-device 317 may be configured to power on automatically when the car/vehicle is in motion and turn off after the car/vehicle remains stationary for a certain amount of time but may also have a manual on/off switch. While the end-device 317 is on, it may either display the participant’s response if they have already voted or may simply wait for a participant’s response if they have not voted yet. As discussed previously, in order to prevent an end-device 317 from voting more than once for a specific question, a “TLock” may be provided that prevents additional responses from being accepted until the time allotted to the current vote has passed and a new voting period has begun. In other words, the time lock may be configured to ignore responses from a participant if the end-device has already received a response from the participant within the voting period, and may also ignore responses from a participant that are not received during a voting period (e.g., responses submitted before a voting period starts and responses submitted after a voting period ends). Said TLock may operate using an internal clock disposed within the end-device 317 that is synchronized with the clock of the datacenter. The end-device may also be fitted with GPS device or other location verification device that may supply locational metadata to be used when filtering or otherwise isolating data during data processing. The GPS device may be configured to record the GPS coordinates of the end-device at the time that the participant’s response is inputted. If privacy is a concern for the voter, the GPS may be omitted or disabled, or alternatively be configured to give a less accurate reading, such that the general area of the voter is collected, rather than their specific location.

The participant’s response may be converted to voting data and transmitted by the end-device 317 to be received or otherwise detected by a data collector 316 having a data collector camera 316c for detecting a visible/IR voter light and/or a transceiver 316a for detecting answers sent by a transceiver on the end-device 317. Such data collectors 316 may implement suitable technologies to be compatible with end-devices 317 provided in a vehicle and implement suitable wireless protocols to properly communicate with said end devices 317, as described hereinabove. Data collectors 316 may be configured to receive voting data from an end-device 317 present in each vehicle that passes within range said data collector 316. The data collectors 316 may utilize a security layer to ensure data integrity, prevent information leaks and protect against potential attacks. The data collectors 316 may also perform local pre-processing on the collected voting data in order to extract relevant information as needed. The data collectors 316 may act as an intermediary between the end-devices 317 and the datacenter 301 by transmitting all received voting data from the end-devices 317 to a database(s) 311 connected of the datacenter 301.

The datacenter 301 may perform cloud computing and other additional operations pertinent to the remote surveying method, including providing security, providing a database 311 to store the collected answer data (e.g. the complete dataset), processing said collected answer data 319a and generating statistics 319b from said voting data. Cloud computing may be utilized by the datacenter 301 in order to convert the received voting data into survey results, as disclosed herein. The datacenter 301 may be based out of remote computer center(s) that handle the various responsibilities of said datacenter 301. The datacenter 301 may implement various security measures known in the industry to ensure the safety and integrity of the collected data, prevent external attacks, and prevent injection of data from malicious sources. For example, a firewall may be implemented within the datacenter 301 to ensure only those with authorized access may interact directly with said datacenter 301. The datacenter 301 may provide a database 311 as part of the data management module to store all voting data captured by each of the data collectors 316 linked to said datacenter 301. The datacenter may also hold additional information, such as allowable voting times (the timespan of the voting period) and zones to be used in conjunction with collected answer data and may be configured to detect and omit duplicate answers from each end-device 317 through the utilization of the unique end device ID numbers included as metadata within the corresponding voting data. As seen in FIG. 3, the various elements of the datacenter 301 may operate as a cloud-based systems and may utilize a serverless architecture consistent with other serverless architectures known in the industry.

As described previously, metadata collected as part of the voting data by the end-devices 317 or the data collectors 316, including the serial number, unique ID of the end-device 317, place of reception and arrival time of vote, etc., may be compiled alongside the participant’s response to form the corresponding voting data. In addition to holding and securing the complete dataset of voting data, the datacenter 301 may also process the voting data based upon the captured metadata and generate statistics based on the metadata to provide to a surveyor/client. Statistics may be generated by filtering the collected voting data based upon end user or surveyor elected parameters, in order to ensure utilization of only information pertinent to the data of interest. For example, a statistic may be generated through utilization the voting data collected from a singular data collector 316, through the use of locational metadata, in order to determine the opinions of drivers that utilize a specific intersection in which said data collector 316 is stationed. The utilization of filters to isolate desired data may be implemented at an appropriate stage or module of the real-time remote surveying process, such as the numeration module. The statistics generated within the datacenter 301 and any other post processed data, as well as the unprocessed voting data collected by each data collector 316 and may be stored within the database server 311 provided through the datacenter 301.

The statistics generated within the datacenter 301 may be displayed to the surveyor, client or other end user through a machine having graphic user interface 320 and access to the voting data database of the datacenter 301. The client/surveyor accessing the database may also be described as allowing the numeration module (specifically the client machine component of the numeration module) to query the data management module (specifically the database/ database server component of the data management module), thereby allowing the client/surveyor to access survey results, voting data, etc. This graphic user interface 320 may not perform any information processing and may instead provide a front-end access point for the end user, client or surveyor to view the generated statistics and collected voting data accessible through the datacenter 301 via a network connection. This user interface 320 may allow users to change the way that the data is presented to them, allowing an end user to swap between tabulated data, log files, and graphical representations of the same information. The user interface 320 may be part of a conventional electronic device, such as a computer or a smart device, that is in data communication with the datacenter 301.

In addition to the above provided remote surveying elements, an audit system 318 may be implemented as an independent data verification system. This audit system 318 may include elements functionally comparable to those found in the data collectors 316 and the datacenter 301, with the audit system 318 having its own independent audit system data collectors 318a, data processing means 318d, statistics generation means (not shown), and result reporting means (not shown), effectively providing a mechanism for verifying the results generated by the datacenter 301. Unlike the previously mentioned datacenter 301 and user interface 320 that is intended for end users and surveyors only, this audit system 318 may be made accessible to the public. The audit system data collector 318a may implement technologies comparable to those of data collector 316 of the main system, including using an audit camera 318c and/or an audit signal transceiver 318b to detect a voting light or signal emitting end-device, respectively. As with voting data collected by the datacenter 301, the voting data collected by the audit system 318 may be processed to generate pertinent statistics and graphics, such as the local survey results described hereinabove. All voting data collected by the audit system data collectors 318a may be stored and processed separately from any answer data collected by the datacenter 301 through the use of an audit processing system 318d. The data processing, statistics generation and result reporting of the audit system 318 may be done by audit processing system 318d that performs operations comparable to the datacenter 301 and user interface 320, but displays the generated graphics, tabulated data, and other data to an audit system user, rather than an end user/client. The data collected and results generated by the audit system 318 may be accessed by the general public and used in order to verify those of collected and generated by the datacenter, thus acting as an independent verification method to ensure result integrity.

As discussed previously, elements of the disclosed modules may be used to filter the voting data acquired or displayed based upon the needs of the client/end user. As such, limitations and voting restrictions may be applied prior to data collection, and/or post-processing adjustments may be applied after voting data collection. The ability to only collect data from a specific location may be implemented to allow voting data to be collected from a certain subset of participant, such as ones near a specific data collector 316, for example. Alternatively, all filtering may be reserved for post processing by the numeration module after all of the voting data is collected. This method of applying post-processing filters to a complete and unbiased collection of voting data, rather than only collecting a pre-filtered subset of voting data, may be preferred, as filters may be applied or removed at will, based upon the preference of the end user without omitting data from the original answer data collection (e.g., the complete dataset).

FIG. 4 illustrates a computer system suitable for implementing the aspects of an end-device within the disclosed remote surveying system, according to an aspect. As described hereinabove, a computer system 421 suitable for use as an end-device within the disclosed real-time remote survey system must be properly equipped to facilitate its required functionalities as a voting module-based end-device, such as end-device 117 of FIG. 1. The disclosed computer system 421 may be comprised of a wireless communication engine 422, a processing unit 423, a user input interface 424, a real time clock 425, a lighting system 426, a volatile memory unit 427, a non-volatile memory unit 428 and an optional GPS module 429. Each of the computer system components may be in communication with an electrical communication system 430 in order to facilitate their intercommunication. The disclosed computer system 421 may utilize more or fewer elements in order to suitably accommodate the desired application of the end device.

The wireless communication engine 422 may be used to allow the end-device to communicate with a data collector in order to facilitate the transfer of voting data. The wireless communication engine may also be configured to enable end-device to end-device communications for application in which said communication would be pertinent. The wireless communication engine 422 may be any suitable transceiver to send the voting result and accompanying metadata to the data collector. This transceiver may operate through wireless protocols such as LoRaWAN, SigFox, NB-IOT, cellular, Wi-Fi, Bluetooth, mesh architectures, etc. A comparable transceiver may also be present on the data collector in order to facilitate the communication between each end device and said data collector.

The processing unit 423 may be any known processor that is suitably capable of performing the processing functions to ensure end computer system functionality. Said processing unit may execute corresponding commands when receiving the vote from the participant in order to send the results via wireless communication and visibly through the lighting system.

The user interface 424 may be any suitable structure through which the user may manually interact with the end-device in order to input their answer. For an end device that is designed to respond to “yes” or “no” questions, or other styles of questions with binary style responses, the user interface may be one “yes” button and one “no” button, wherein the voter may simply press the button corresponding to their response to have it captured by the end device. Other style of questions that have more than two possible responses may necessitate the usage of addition buttons or an alternative style of user interface, such as a selection dial, to cycle through options and confirmation button to select one of said options.

The real time clock 425 may be provided on the end-device in order to record the time that the answer was collected as well as prevent additional votes from being cast by the same device while in the present voting period. The usage of the real time clock 425 may allow for time-based metadata to be sent alongside the inputted answer, such that an “answer-to-question” relationship may be formed. In instances in which different questions are asked at the same time, but in different broadcast ranges, additional metadata, such as locational data, may be required to establish an “answer-to-question” relationship. The real time clock 425 may lock and unlock the voting unit to prevent the collection and broadcast of duplicate votes, or the collection of votes beyond the allotted time frame (e.g. outside of a valid voting period). Said real time clock 425 may be synchronized with a network time set within the datacenter via communication with the data collector.

The lighting system 426 may be provided as part of the end device in order to provide a visible indication of voter participation. The lighting system 426 may emit a colored light or a particular pattern/shape/etc., of light in order to indicate how the voter has responded to the broadcasted question. This lighting system 426 may be useful not only for allowing the voter to confirm their participation, but also for allowing the nearby public to visually audit the results in real-time. The light emitted by the lighting system 426 may also be captured by camera as part of the data collector, wherein the light-based data collector may utilize a processing image algorithm in order to analyze and capture the light-based results. As a result of the public visibility of the lighting system allowing voting results to be audited by anyone visually, the reliability of the voting results may be increased. The lighting system 426 may also utilize infrared lights with different patterns, in order to allow specialized cameras to also collect information from nearby voting devices.

Much like many other computing systems, the disclosed end device may also utilize a form of volatile memory 427 and a form of non-volatile memory 428 in order to perform essential data storage and command execution functions to ensure device functionality. The functions these memory types may be consistent with those in the industry, wherein the volatile memory 427 would be used for temporary storage during device operation, and the non-volatile memory 428 would be used for permanent storage. The potential forms of the volatile memory 427 and the non-volatile memory 428 within the computing system 421 may also be consistent with their equivalents in the industry, with the volatile memory 427 potentially being a RAM unit and the non-volatile memory being a storage unit, such as a flash or EPROM memory unit. The volatile memory 427 may be utilized by the processor to execute commands, whereas the non-volatile memory may be where the program it operates from, communication parameters and the device identification unit is stored.

The disclosed computing system 421 may also utilize a GPS unit 429 as part of the end device. This GPS unit may be used in situations in which locational metadata may be needed or useful, and said locational metadata is not captured based off of the positioning of the data collector. The GPS unit 429 may be optional and not necessary for participation, as exact global positioning is often unnecessary to isolate a response to a particular region, and thus form the needed “answer-to-question” relationship between the voter’s provided answer and the question that was broadcasted to them. Said locational GPS data may be stored alongside the voting results as metadata, as described hereinabove.

Each of the aforementioned computer system elements may be in electrical communication with an electrical communication system 430 in order to facilitate the proper intercommunication of each element. The electrical communication system 430 may operate as an electrical hub, providing power and proper communication channels between each element as needed. The electrical communication system may use known electrical connectors, such as electrical wires, in order to facilitate the described interconnection of elements. The disclosed end-device computer system 421 elements may be modified or selectively implemented depending on the specific needs of the end-device’s application and the mechanisms through which it is intended to operate. In addition to the elements of the end device computer system 421, additional end device elements, such as a speaker, used to facilitate the prior discussed confirmation audio cue from the process described in FIG. 1, and an independent power source, such as a rechargeable battery, may also be implemented as needed. Alternative end device elements, such as a visual user interface (not shown) may also be implemented in certain variations of the disclosed end device, wherein said visual user interface may be configured to display the question, the voter’s inputted response, or any other relevant information to the voter.

The disclosed end device when used in conjunction the other real-time remote surveying elements described hereinabove may allow for the rapid collection of voting results and any necessary metadata from voters, processing of said voting results and metadata into survey results, and distribution of survey results to clients in real-time. As a result of this, surveys may be conducted with minimal effort required from either the participants/voters or the client(s)/end users who are conducting the survey. The various modules of the application server may facilitate the discussed autonomy of the disclosed real-time remote surveying system and method by providing instruction for each end device, data collector and datacenter element. The disclosed remote surveying process may implement additional steps or devices based upon the requirements of the application and or the needs of the client/surveyor.

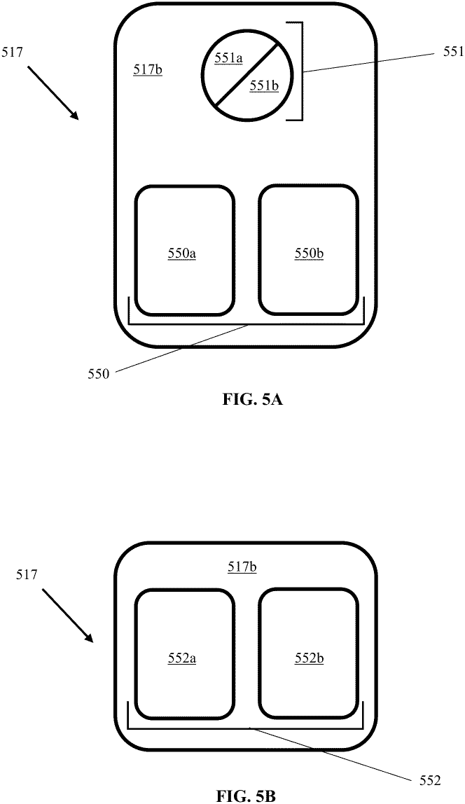

FIG. 5A illustrates a front view of an embodiment of an end device 517 having selection buttons 550 and voting lights 551, according to an aspect. FIG. 5B illustrates a front view of an embodiment of an end device 517 having illuminated voting buttons 552, according to an aspect. As disclosed hereinabove, a participant may interface with an end device 517 in order to allow them to submit a response/vote to a particular survey. This end device 517 may be configured to be mounted within a car to allow for its suitable positioning as detailed herein. In an embodiment, the end device 517 may be comprised of a plurality of selection buttons 550 and a voting light 551 disposed on an end device body 517b. The selection buttons 550 may be in electrical communication with the voting lights 551 such that pressing a selection button 550a, 550b illuminates the corresponding voting light 551a, 551b. In an example, a participant may press a first selection button 550a corresponding to a “yes” answer, resulting in the illumination of a corresponding first voting light 551a. In another example, a participant may press a second selection button 550b corresponding to a “no” answer, resulting in the illumination of a corresponding second voting light 551b. These buttons 550 and voting lights 551 may be color coded to make their identification easier for the participant, as well as data collectors which utilize cameras and members of the public.

In an alternative embodiment, illuminated selection buttons 552 may be disposed on the end device body 517b instead of separate selection button 550/ voting light 551 structures. Upon a corresponding illuminated selection button 552 being pressed, it may itself become illuminated. In an embodiment, pressing the first illuminated selection button 552a may result in the first illuminated selection button 552a glowing a particular color, whereas pressing the second illuminated selection button 552b may result in the second illuminated selection button 552b glowing a different particular color. Such illuminated selection buttons 552 may be preferred in certain embodiments to minimize the overall size of the end device 517. It should be understood that in each iteration of the end device 517, the selection button 550 or illuminated selection buttons 552 may be configured to be easily accessed by the participant, whereas the voting lights 551 and illuminated selection buttons 552 may be configured to be seen by any corresponding data collectors having a corresponding sensory device (e.g., a camera) or nearby members of the public. It should be noted that each end device 517 may utilize more selection buttons 550, voting lights 551 or illuminated selection buttons 552 accordingly, based upon the type of question that are being broadcasted and how may answer selections are available.

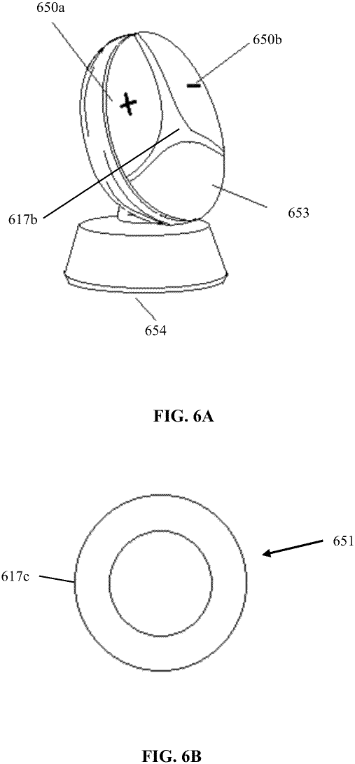

FIG. 6A illustrates the front perspective view of an embodiment of mountable end device 617, according to an aspect. FIG. 6B illustrates a front view of a windshield mountable voting light 651, according to an aspect. Each end device 617 and its various elements, such as the voting light 651 may be fitted accordingly with the appropriate devices to ensure that they remain affixed to a vehicle or other structure in which they are intended to be provided. In an embodiment, an end device 617 may be further comprised of an end device suction cup 654 engaged with the end device body 617b, wherein the end device suction cup 654 is configured to securely engage with a suitable surface, such as the dashboard or console of a participant’s vehicle. By securely mounting the end device 617 within a participant’s vehicle, potential sliding or loss of the end device 617 during driving may be avoided.

In order to facilitate the proper positioning of the selection buttons 620a, 620b and the voting light 621 to ensure their corresponding function may be optimally achieved, it may be desirable to have the voting light 621 and selection buttons 620a, 620b be disposed on separate structures. In an embodiment, the selection buttons 620a, 620b may remain disposed on the end device body 617b, whereas the voting light 621 may be disposed on a separate, auxiliary end device body 617c. This auxiliary end device body 617c may be in communication with the end device body 617b, either wirelessly or through the use of a connecting wire (not shown), such that communication between the voting light 621 and their corresponding selection buttons 620a, 620b is maintained. The auxiliary end device body 617c may be configured to securely attach to the windshield of a participant’s vehicle, such that the voting light is visible to members of the public and corresponding camera based data collectors, whereas the end device body 617b may be configured to securely attach to the dashboard or console of the participant’s vehicle, to ensure a participant may reach the corresponding selection buttons 620a, 620b without undue effort.

As disclosed previously, each end device 617 may also be fitted with a switch configured to prevent the voting light 621 from showing the participants response, if they wish to vote anonymously in a manner not visible to nearby voters. This switch may be referred to as an anonymity button 653, and said anonymity button 653 may be selectively toggled to turn on or off the voting light 651, thus showing or hiding the participant’s response accordingly. It should be understood that the end device 617 may still be configured to transmit voting data to a data collector that is in data communication with the datacenter, such as datacenter 101 of FIG. 1, but if the user wished to not have their vote seen by the general public, they may choose to utilize the anonymity button 653 as they see fit, to maintain their privacy as desired.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be rearranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. A real-time remote surveying system comprising:
a plurality of end-devices, each end-device of the plurality of end-devices being configured to receive a response from a corresponding participant and automatically generate corresponding voting data in real-time;
a broadcasting system configured to broadcast a question to each participant;
at least one data collector configured to be in data communication with each end-devices of the plurality of end-devices and the internet, each data collector of the at least one data collector being configured to receive voting data from each end-device of the plurality of end-devices;
a datacenter configured to be in data communication with the internet, such that the datacenter is in data communication with the at least one data collector, the datacenter comprising:
an application server having a plurality of modules configured to facilitate operation of the real-time remote surveying system; and
a database server in data communication with the application server, the database server being configured to receive voting data from the at least one data collector and compile the voting data from each data collector to form a complete dataset;
wherein the datacenter is configured to process the complete dataset to automatically generate survey results in real-time; and
a client machine configured to be in data communication with the internet, such that the client machine is in data communication with the datacenter, the client machine being configured to query the datacenter to allow an end user to access the survey results in real-time.

2. The real-time remote surveying system of claim 1, wherein the question is a survey question.

3. The plurality of end-devices of claim 1, each end-device of the plurality of end-devices comprising a lighting system configured to display the response from the corresponding participant to nearby individuals.

4. The plurality of end-devices of claim 1, each end-device of the plurality of end-devices comprising a GPS system configured to automatically record GPS coordinates of the end-device in real-time when the response is received.

5. The real-time remote surveying system of claim 1, further comprising an audit system, the audit system comprising:
an audit system data collector in data communication with the plurality of end-devices, the audit system data collector being configured to collect voting data from the plurality of end-devices; and
an audit processing system configured to store voting data collected from the plurality of end-devices and process the voting results collected from each end-device into local survey results, wherein the audit system is configured to be accessible to the general public, such that a member of the general public may access the local survey results generated by the audit system without interfacing with the datacenter.

6. The real time remote surveying system of claim 1, wherein each data collector is configured to be positioned on a freeway, such that each data collector is configured to receive voting data from participants that are driving vehicles on the freeway.

7. The real-time remote surveying system of claim 1, each end-device of the plurality of end-devices comprising a time lock configured to ignore responses from a participant if the end-device has already received a response from the participant within a voting period, and ignore responses from a participant that are not received during a voting period.

8. A real-time remote surveying system comprising:
a survey module configured to transmit a question to participants and have the questions be received by the participants;
a voting module in data communication with the survey module, the voting module being configured to record participant responses to the question, automatically generate voting data and transmit the voting data;
a numeration module in data communication with the voting module, the numeration module being configured to receive voting data from the voting module and automatically produce and display survey results in real-time; and a data management module in data communication with the numeration module, the data management module being configured to store voting data and survey results.

9. The survey module of claim 8 comprising a radio station configured to broadcast a question and a radio configured to receive the question.

10. The voting module of claim 8 comprising an end-device having a user input interface configured to receive a yes or no answer from a participant, a lighting system configured to display the corresponding participant’s response to nearby individuals, and a transceiver configured to transmit voting data from the end-device to the numeration module.

11. The numeration module of claim 8 comprising a data collector having a transceiver, the numeration being configured to transmit voting data from the voting module to the data management module and process voting data received from the voting module into survey results through cloud computing.

12. The data management module of claim 8 comprising a database server configured to store voting data and survey results on a database and allow the numeration module to query the database.

13. A method of real-time remote surveying comprising the steps of:
broadcasting a question;
facilitating the receipt of the question by a plurality of participants;
allowing each participant having an end-device of the plurality of participants to input a response to the question into a corresponding end-device;
generating voting data automatically in real-time from each participant’s input response;
facilitating the transmission of the voting data from each end-device to at least one data collector;
transmitting voting data from the at least one data collector to a datacenter;
storing the voting data from each data collector on a database server, the voting data transmitted from each data collector being compiled into a complete dataset;
processing the complete dataset stored within the datacenter into survey results; and
allowing an end user to access the survey results in real-time through a client machine in data communication with the datacenter.

14. The method of real-time remote surveying of claim 13, further comprising the step of allowing a member of the public to audit local survey results using an audit system, the audit system comprising an audit system data collector configured to collect voting data from each end-device and an audit processing system configured to process the voting data from each end-device into local survey results.

15. The method of real-time remote surveying of claim 13, wherein broadcasting a question is performed by broadcasting a radio signal having a question to be received by a participant’s radio.

16. The method of real-time remote surveying of claim 13, further comprising the step of accepting filtering parameters from an end user and applying the filtering parameters to the complete dataset prior to processing the complete dataset into survey results.

17. The method of real-time remote surveying of claim 13, wherein the voting data automatically generated by each end-device comprises a corresponding participant’s anonymously submitted response and metadata.

18. The method of real-time remote surveying of claim 17, the metadata comprising GPS coordinates at which the corresponding participant input the response, a time the participant input the response, and a device ID unique to the corresponding end-device.

19. The method of real-time remote surveying of claim 13, wherein the step of broadcasting a question comprises:
providing a question to a radio station operator;
allowing the radio station operator to transmit the question over radio transmission.

20. The method of real-time remote surveying of claim 13, further comprising the step of illuminating a voter light disposed on each end-device based upon the corresponding participant’s response.
